(19) United States
(12) Patent Application Publication
(10) Pub. No.: US 2024/0174507 A1
(43) Pub. Date: May 30, 2024

(54) SADDLE WITH COMMEMORATIVE BUCKLE ATTACHMENT MECHANISM

(71) Applicant: Josey Enterprises, INc., Karnack, TX (US)

(72) Inventors: Martha La Vonne Josey, Karnack, TX (US); Gary Jonas Arthur, Karnack, TX (US); Cindy M. Durham, Karnack, TX (US)

(73) Assignee: Josey Enterprises, Inc., Karnack, TX (US)

(21) Appl. No.: 18/060,533

(22) Filed: Nov. 30, 2022

(51) Int. Cl. B68C 1/02

(52) U.S. Cl. CPC B68C 1/02

(57) ABSTRACT

A saddle adapted for securing and displaying a commemorative belt buckle is disclosed. The saddle, has a skirt or cantle portion. A faux belt has a first end secured to the saddle skirt or cantle portion and a second end. The faux belt is adapted to be removably secured to the commemorative belt buckle via a bar and post of the commemorative buckle and one or more holes through the faux belt. A belt securing element removably secures second end the faux belt to the saddle skirt. Alternatively, the saddle includes a belt adapted to be secured in a skirt or cantle portion of the saddle, and the commemorative belt buckle is adapted to be removably secured to the belt via a bar and post of the commemorative buckle and one or more holes through the belt. The commemorative belt buckle is removably secured to the saddle.

### FIELD OF THE INVENTION

The present invention relates to saddles for animals such as horses, and more particularly to a saddle, particularly a western-style saddle, having a buckle attachment mechanism for attaching a commemorative-type buckle to the saddle that provides visual display of the commemorative buckle while not impeding competitive riding of the horse such as in barrel or other horse races or competitions.

### BACKGROUND OF THE INVENTION

Competitions involving horses provide a great deal of excitement and personal fulfillment and other rewards for participants, spectators and others that put on competitions or just love horses. Western events such as Roping, Barrel Racing, Cutting, Team Penning, Ranch Sorting, Reining, Working Cow horse, Competitive Trail, Bull Dogging, and Saddle Bronc Riding are examples of these types of events.

A wide variety of saddles and saddle types have evolved over the years. One type of saddle is commonly known as a western-style saddle. This type of saddle, regardless of name, is typically designed to enhance the rider's ability to stay with their horse while competing in the types of competitions listed above. Such saddles generally are designed to serve the competitive needs of the rider, and also are generally considered items of aesthetic beauty. The appearance of the saddle is an important attribute.

A common reward or commemoration of winning or placing in a competition is the awarding of commemorative belt buckles. A winner or champion in a particular event might be awarded a western style belt buckle denoting the achievement. Belt buckles, particularly western-style belt buckles, denoting status or results of a competition, rank, membership in a group, etc., are widely cherished in many events, particularly western-style competitions.

Western style commemorative belt buckles are designed for use on belts worn by a human. Other times, such belt buckles are displayed such as in a display case. Displaying such commemorative belt buckles when riding a horse, would add value and enjoyment to the rider and spectators.

### SUMMARY OF THE INVENTION

The present invention provides a variety of ways to secure and display commemorative type belt buckles (or other design belt buckles) on horse saddles. In accordance with preferred embodiments of the present invention, a commemorative, western-style belt buckle is removably securable to the saddle in a manner to be visible to spectators while not impeding the rider's performance while riding the horse such in a competition, parade or other circumstance.

In certain preferred embodiments, a faux belt, or belt portion, is provided that can engage with western-style belt buckles and be removably secured to the saddle such as with an additional buckle, such as a small Conway buckle. Other types of securing mechanisms for securing a preferably western style, commemorative belt buckle are used in other embodiments, an arrangement that has the appearance of a belt and is removably securable to the saddle is particularly advantageous. Locations for the commemorative belt buckle are, as examples, on one or both sides of the skirt of the saddle, preferably a rear portion of the skirt, and/or on the backward facing portion of the cantle.

Variations and alternatives are provided in the detailed description to follow.

Accordingly, it is an object of the present invention to provide saddles with elements to secure a commemorative or other type of belt buckle to saddles.

It is another object of the present invention to provide removably securable mounting mechanisms for commemorative or other types of belt buckles to saddles.

It is yet another object of the present invention to provide ways for riders to display commemorative or other types of belt buckles in one or more locations on the saddle, such as to make the belt buckle visible to spectators while not impeding the rider as the rider rides the horse such as in competitions or parades or other events.

### BRIEF DESCRIPTION OF THE DRAWINGS

The above objects and other advantages of the present invention will become more apparent by describing in detail the preferred embodiments of the present invention with reference to the attached drawings in which:

FIG. 1 illustrates a side view of a saddle tree:

FIG. 2 illustrates an underside view of a saddle tree:

FIG. 3 illustrates a front view of a saddle tree:

FIG. 4 illustrates a side view of an assembled saddle known as a Martha Josey Saddle:

FIG. 5 illustrates an underside view of an assembled Martha Josey Saddle:

FIGS. 6 and 7 illustrate parts of a western-style belt buckle:

FIGS. 8 and 9 illustrate the use of a western-style belt buckle used with a western-style belt:

FIG. 10 illustrates a topside view of a faux belt attached to an exemplary rear portion of a saddle:

FIG. 11 illustrates an underside buckle view of a western-style buckle being attached to a faux belt attached to an exemplary rear portion of a saddle:

FIG. 12 illustrates a commemorative belt buckle removably secured to an exemplary rear portion of a saddle in accordance with certain preferred embodiments of the present invention:

FIG. 13 illustrates a commemorative belt buckle removably secured to an exemplary Martha Josey Saddle and located in a rear skirt portion of the saddle in accordance with certain preferred embodiments of the present invention:

FIG. 14 illustrates a commemorative belt buckle removably secured to an exemplary Martha Josey Saddle and located on the cantle of the saddle in accordance with certain preferred embodiments of the present invention: and

FIG. 15A to 15C illustrate an alternative preferred embodiment using a miniature western-style to provide a commemorative belt buckle removably securable to a saddle:

FIGS. 16 to 22 illustrate various securing mechanisms to secure a belt to a post of a belt buckle in accordance with alternative preferred embodiments of the present invention.

### DETAILED DESCRIPTION OF THE PREFERRED EMBODIMENTS

The present invention will be described in greater detail with reference to certain preferred and alternative embodiments. As described below, refinements and substitutions of the various embodiments are possible based on the principles and teachings herein.

By way of background and not limitation, parts of an exemplary western-style saddle will be described. As is known in the art, a western saddle is specially designed to enhance the rider's ability to stay with their horse while competing in western events such as Roping, Barrel Racing, Cutting, Team Penning, Ranch Sorting, Reining, Working Cow horse, Competitive Trail, Bull Dogging, and Saddle Bronc Riding. In addition to Western Style Competitions, a western saddle is also designed to assist real working cowboys be more effective at their various jobs on the ranch that must be done via horseback. It should be understood, however, that the present invention may be adapted to work to work with saddle types other than western saddles. What is important is that the saddle have an area, such as a skirt or cantle, on which the commemorative belt buckle may be located (and secured as described herein) and not impede the rider's ability or cause discomfort for the rider or the horse. Other exemplary saddle types include what is known as a western treeless saddle, a Mexican charro saddle, and other saddles having a skirt, a cantle or similar area for securing a commemorative buckle in a manner as described herein.

Almost all western-style saddles are built and designed around what is called a “tree”. The tree in a western saddle is a typically solid piece that is specially formed to fit both a horse's back and the rider's body. Most trees are made from some type of wood wrapped in rawhide or wood wrapped in fiberglass. There are some saddle trees that are made from Ralide (plastic), or other less sturdy materials, but these are generally simple trail saddles for the casual rider. In preferred embodiments, the present invention is used with saddles known as Martha Josey Barrel Saddles™, which are adapted for the rigors of barrel racing. Trees for Martha Josey Saddles™ typically are made from a lightweight wood and wrapped in a strong fiberglass.

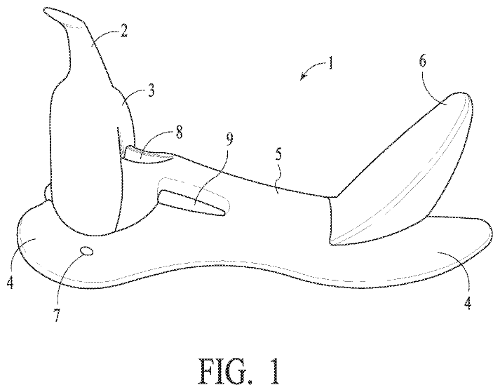

Referring now to FIG. 1, exemplary of a western saddle tree will be described.

Bars 4 of tree 1 are what fit on the horses back. The rider's body sits in seat 5. Pommel (or swells) 3 and cantle 6 assist in keeping the rider more secure, which is important when competing in speed events such as barrel racing. These pieces also tend to keep bars 4 in place. Horn 2 is sometimes used for extra leverage or support when riding, and with certain saddles is used to secure a rope when working with cattle or the like. Fender leather holes 9 are where the fenders typically are attached through the tree for added strength. Stirrup leather pivot points 7 are specific to Martha Josey Saddles. Pivot points 7 are where the stirrup leather (described hereinafter) attaches and can free swing on a ball bearing for better rider body placement while barrel racing. Hand hole 8 is there, for example, for ease of carrying from tack room to horse.

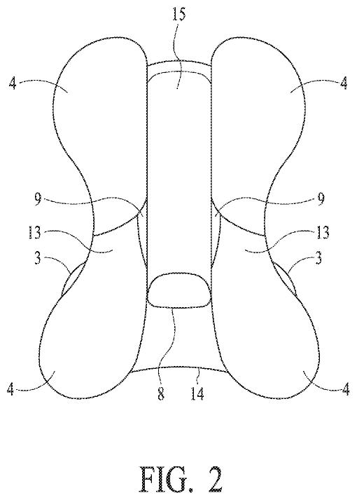

Referring now to FIG. 2, the underside of tree 1 will now be described. In FIG. 2, the front of the saddle should be understood as facing downward in the illustration.

Bars 4 typically are curved from front to back underneath to mimic the curved shape of a horse's back. Bars 4 typically are also angled from side to side to fit the side-to-side curvature of the horse's back. Fender leathers fit through fender leather holes 9 and around tree 1 for strength and security. Channel 15 serves to keep bars 4 steady and secure and reduce pressure on the horse's spine. As before, hand hole 8 is for ease of carrying the saddle. Gullet 14 typically is the measurement area where bars 4 meet pommel 3 (referring both to FIGS. 1 and 2. Gullet width measurement is known to be very important in determining what size tree is needed for the particular horse. Pommel 3 and cantle 6 (in FIG. 1) assist in keeping the bars 4 in place as well as keeping the rider properly positioned in the seat.

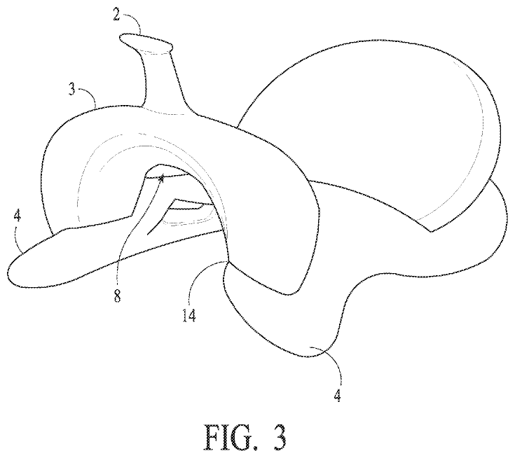

Referring now to FIG. 3, viewing tree 1 from a forward-facing angle more readily illustrates the bar angle. As will be understood by those of skill in the art, bar angle is important to fitting the horse as is the gullet width. Looking at bars 4 from this perspective, it can be seen bars 4 preferably are angled to fit the side-to-side shape of a horse's back. Most trees typically are built with anywhere from approximately a 43° angle all the way up to approximately a 48° angle for a very large horse. Gullet 14 typically is measured from the 2 points where the bars meet the pommel. Gullet 14 typically can range anywhere from 6.5″ to 9″.

Once a tree has been designed and implemented for a saddle build, the external pieces of the saddle are added. These pieces are almost always some type of leather or canvas and are used to provide comfort for both the horse and rider and be of sufficient strength for the intended purpose. Also, different designs are used for aesthetics or to make the saddle more suitable for different types of riding. Variations of such saddles are within the scope of the present invention, as the present invention will be understood to be readily adaptable to a variety of types of saddles, saddle types and saddle variations.

Different designs and saddle variations could be, for example, anything from the color of the leather, adding tooling to certain parts of the saddle, or placing the unfinished side (roughout) of the leather facing outwards for better grip or more rustic design. Sometimes names or lettering are stamped into the leather. Different types of riding will dictate what design a saddle needs. For example, a rope saddle typically will be made of heavier leather and components as compared to a barrel saddle which typically will be designed to be as lightweight as possible in most cases. A bronc riding saddle typically will have the saddle horn removed and be made of full roughout for grip. A trail saddle will often be made with rider comfort in mind, adding extra padding in the seat. A cutting saddle will generally be made with a smooth unpadded seat to allow the rider to sit low and move easily with their horse.

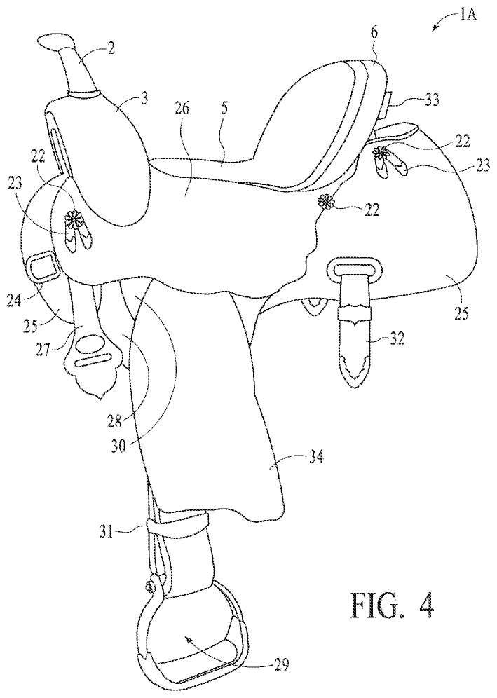

For illustrative purposes, a description will be provided of a Martha Josey Barrel Saddle with reference to FIG. 4.

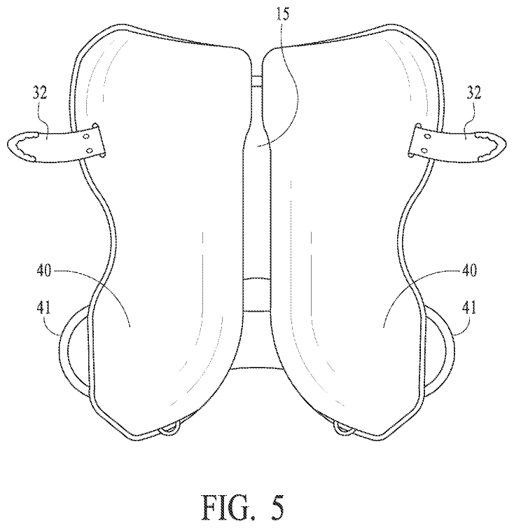

Horn 2 typically is provided for added stability or leverage. Pommel 3 and cantle 6 server to help hold the rider into place. Seat 5 is where the rider sits. Jockey 26 protects the rider's legs from the working parts of tree 1. Fender 34 is a protective layer typically provided between the horse and rider and holds stirrup 29 for the rider's foot. Skirt 25 typically is provided both for aesthetics and protection of the horse from being rubbed by tree 1. Show billet 32 typically is provided for aesthetics but can be replaced with a rear cinch billet (also generally noted as 32), which would connect to a rear cinch to help keep the saddle more secure. Stirrup leather 30 assists with holding the riders' legs in proper position and helps hold stirrup 29. Stirrup hobble 31 preferably is provided as a safety feature on the saddle, by holding the stirrup leather pieces together tightly around stirrup 29. D-ring cover 28 preferably keeps the D-Rings (shown in FIG. 5—these are what attach to the latigos and cinches) from rubbing holes through stirrup leathers 30. Latigo keeper 27 typically is provided for a place to hang the tail of a latigo so it does not come undone. Breast collar D-Rings 24 are for optionally providing a place to attach a secondary piece of equipment called a breast collar. Conchos 22 assist with attaching skirt 25 to tree 1, and futurity knots 23 are optionally provided for aesthetics. Hoof pick holder 33 is optionally provided on cantle 6 as illustrated.

The underside of a Martha Josey Saddle will now be described with reference to FIG. 5.

Shearling or fleece 40 often is a wool sheep skin attached to the underside of the skirt, which both protects the horse's body and assists in filling in gaps where the tree may not make full contact with the horse's back. Sometimes a synthetic shearling is used for a lower price point. Shearling of fleece is secured, often by being sewn, to the underside of skirt 25 to keep it in place. As illustrated, skirts 25 preferably are of a two pieces implementation, leaving channel 15 open and helping to reduce pressure on the horse's spine. D-rings 41 typically are provided to attach latigo straps. Latigo straps typically are a leather or nylon strap (often approximately 2″ wide), which are drawn through the rings of a padded cinch. Such straps provide an ability to adjust how tight the saddle is placed on the horse.

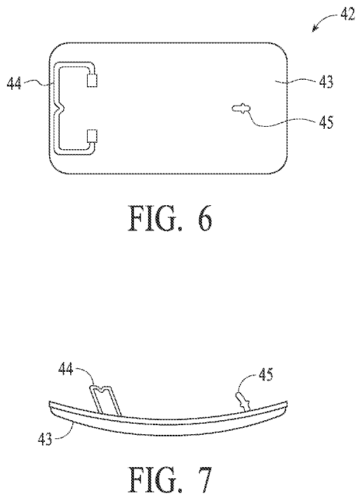

An illustrative western-style belt buckle will now be described with reference to FIGS. 6 and 7.

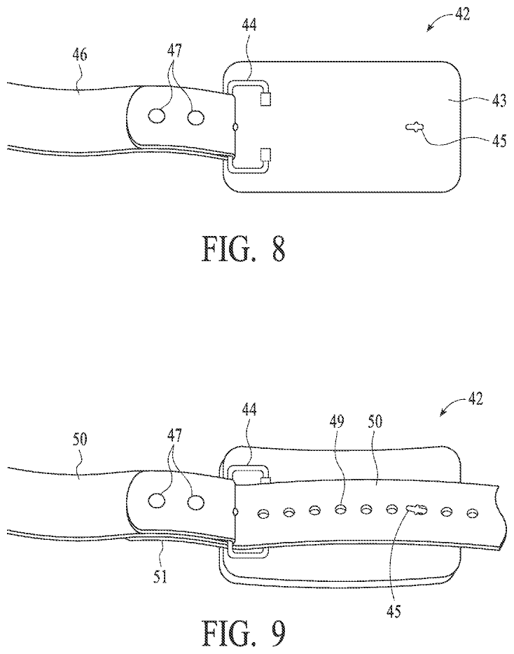

A typical western-style belt buckle 42 includes body 43, bar 44 and post 45. A belt (not shown in these figures) attaches to buckle 42 attaches to belt typically either with two snaps 47 or what is known as Chicago screws 47. In preferred embodiments, rivets are not used so that the buckles may be swapped out easily, but could be used in alternative embodiments. Such snaps or Chicago screws (47 in FIG. 8) are illustrative, and any type of securing mechanism element (one, two, three or other number) are used in accordance with the present invention for removably securing the belt to bar 44 of buckle 42. Such screw type implements may be, without limitation: sex bolts, binding posts, Chicago screws, interscrews, barrel bolts, barrel nut, partition screws, door closure bolts, furniture screws, panel fasteners, architectural sex bolts, arch series screws, hinge screws, display fasteners, screw nuts, connector bolts, threaded rivets, grommet nuts, post and screw sets, and stationary screws. What is important is that a removably securable attachment element or elements is/are provided to removably secure a belt to buckle 42, such as is illustrated. Also as illustrated, the belt head typically is looped through bar 44 and is secured back on itself with snaps/screws 47.

Referring now to FIGS. 8 and 9, how a western-style buckle 42 is used with western-style belt 46 will now be described.

As will be understood to those of skill in the art, to wear belt 46 with buckle 42, belt head 50 loops around bar 44 and is secured by snaps/screws 47, and the body of belt 46 goes around the waist, and is brought back to buckle 42 where holes 49 will line up with body 43 of buckle 42 and belt tail 51 extends past buckle 42. To adjust tightness, post 45 is inserted into a desired one of holes 49 to the desire level of tightness. Post 45 typically is curved or otherwise shaped so that the tension of belt 46 around the waist keeps belt 46 in place. Left over tail 51 of belt then feeds through bar 44 again to lay flat on top of belt 46 generally in belt head 50, as illustrated.

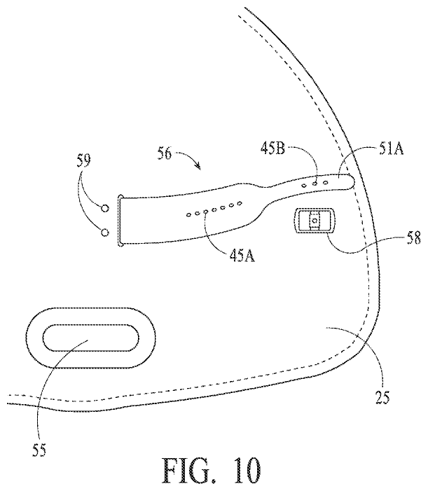

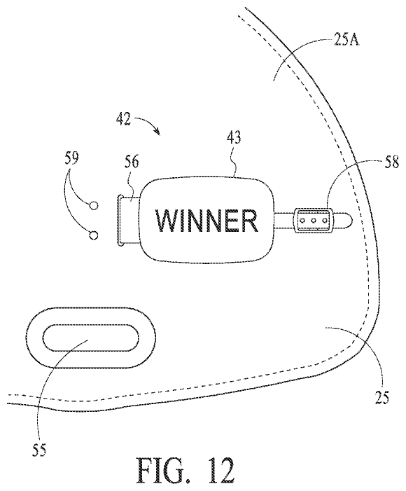

Referring now to FIGS. 10-12, exemplary preferred embodiments adapting “faux” belt 56 to saddle 1A, instead of having an actual western-style belt, so that commemorative buckle 42 may be removably secured to saddle 1A and desirably displayed to observers instead of being wore by a person. Such preferred embodiments are particularly well suited for western-style saddles such as a “Martha Josey Gold Buckle” Saddle. It will be understood that commemorative buckle 42 could signify a winner or champion or other place finisher in some type of competition, or it could signify some other honor, award, team or group affiliation or the like. The present invention is not limited to any particular type of display on commemorative buckle 42.

The “Martha Josey Gold Buckle Saddle” is designed for riders looking for a new way to display their commemorative buckles besides being on a belt they are wearing on their person or in a display case. Most higher level competitors have many buckles from competitions and enjoy displaying them in various ways. In accordance with preferred embodiments of the present invention, saddle 1A incorporates “faux” belt 56 in one preferred embodiment attached to rear skirt 25 of saddle 1A via a preferably permanent attachment, such as one, two or some other number of rivets or screws 59. Faux belt 56 is adapted to secure and display western-style buckle 42 with additional mounting elements as will be herein after explained. In certain exemplary preferred embodiments, the location of commemorative buckle 42 preferably will be above hole 55 for the rear cinch billet facing towards the rear portion 25A of saddle skirt 25. In certain preferred embodiments, faux belt 56 is attached before skirt 25 is attached to saddle 1A, and before saddle 1A is fleeced (i.e., before shearling or fleece 40 is added to saddle 1A. In preferred embodiment, the base of rivet 59 is kept from coming into contact with the horse because it will be between the leather of skirt 25 and shearling/fleece 40. In preferred embodiments, one or more layers of material, including shearling/fleece 40 and possibly additional leather or cushioning material, are between the base of rivets 59 and the back of the horse. Tail end 51A of faux belt 56 preferably buckles into Conway-style buckle 58, which will also be attached to skirt 25 preferably a rivet 58A (or other preferably more-permanent attachment) and a small piece of rawhide through the center of Conway buckle 58. This will allow tail 51A of faux belt 56 to pass through and secure to Conway buckle 58 unimpeded. It should be noted that other styles of buckles or attachment elements are used to secure tail 51A to skirt 25 in alternative embodiments of the present invention.

In the illustrated preferred embodiment, tail 51A is of first width, e.g., 1″, and adapted to work with a 1″ Conway buckle 58, while the base of faux belt 56 that will be positioned under the interior portion of buckle 42 is of a second width, e.g., 2″, and adapted to fit most convention western-style buckles 42. Thus, the base of faux belt 56 will be wide enough to be snug on buckle bar 44 of most western-style buckles for better security in mounting to saddle 1A. Preferably, the first width is equal to or less than the second width, which provides a wider belt portion to engage with conventional commemorative buckles 42 yet be secured with a tail end 51A and mounting element (Conway buckle 58) that is small in size and less in weight. In other embodiments, other sizes of tail end 51A and Conway buckle 58 are used (again, the Conway buckle being used in certain preferred embodiments, and other securing buckles or elements being used in alternative embodiments. Tail end 51A also preferably is tapered for both aesthetics and because it is easier to feed through Conway buckle 58.

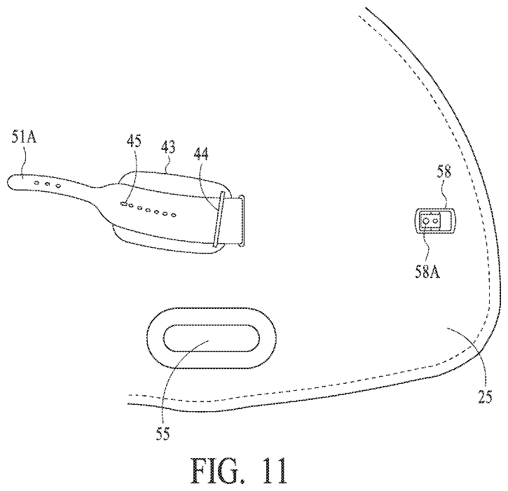

As illustrated in FIG. 11, bar 44 of buckle 42 will slide over faux belt 56, and post 45 of buckle 42 will be inserted into, and attach to, one of holes 45A chosen by a user for aesthetics and stability. As be appreciated by those of skill in the art, buckle 42 can be positioned such that post 45 is pushed through one of holes 45A, and tail 51A of faux belt 56 and pulled to a desired degree of tightness and secured via a projection from Conway buckle 58 into one of holes 45B securing the commemorative buckle and faux belt combination to saddle skirt 25.

It also should be understood that saddle skirt 25 includes a single part skirt and multi part skirts. For example, the present encompasses and may be used with a “double skirt,” in which a secondary smaller rear skirt is positioned/assembled on top of the main rear skirt. Such a multi part skirt is typically found in roping saddles and cutting saddles, and typically added strength and stability as the tree is attached in a slightly different manner to the lower skirt, and the top skirt covers the attachment and adds to the aesthetics of the saddle. Various embodiments of the present invention utilize a skirt having a lower skirt and an upper skirt as described herein.

What should be understood from the foregoing discussion, in accordance with certain preferred embodiments, faux belt 56 is secured to saddle skirt 25 via rivets (other securing element) 59 and adapted so that commemorative buckle 42 may be removably secured to saddle skirt 25 via faux belt 56 and securing element/Conway buckle 58. Thus, a user may removably secure a first commemorative buckle to saddle 1A at a first point in time, and at a later point in time remove the first commemorative buckle and thereafter removably secure a second commemorative buckle to saddle 1A for later display and enjoyment.

In accordance with certain preferred embodiments, the inventive faux belt connection elements are provided to both left and right sides of saddle 1A, preferably toward rear portion 25A of skirt 25 (although in other embodiments, the faux belt connection elements are provided on only a single side, left or right, of saddle 1A. The exact location may be adapted depending on the length, drop length (the measurement of the skirt from top to bottom) and shape of skirt 25. Preferably all rivets 59 or 58A (or other securing elements) should be located a distance away from the edge of skirt 25 to reduce the risk pulling through or endangering the structure of saddle 1A. Preferably, the location will be symmetrical with both the design of the saddle and the shape of the buckle for desirable aesthetics and secure attachment of buckle 42 to saddle 1A.

FIG. 13 illustrates a complete saddle 1A, illustrating a preferred placement of buckle 42 on skirt 25, secured via faux belt 56 and Conway buckle 58.

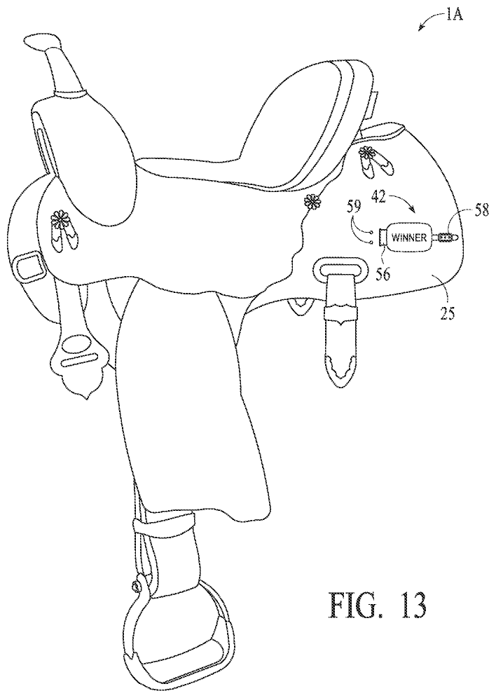

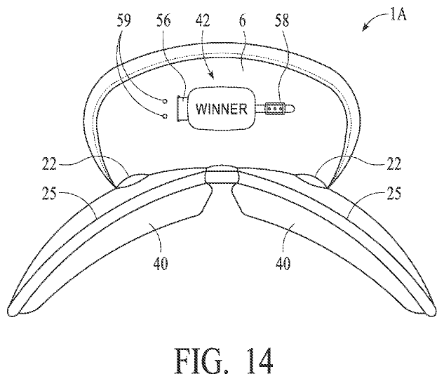

FIG. 14 illustrates an alternative location for a faux belt, commemorative buckle mounting implementation in accordance with alternative embodiments of the present invention. As illustrated, a location can be provided on cantle 6 of saddle 1A, which may be advantageous if the user only wants one buckle on their saddle, in a symmetric or central position. In such embodiments, hoof pick holder 33 of FIG. 4 may be relocated to either skirt (or the rear off billet) and the faux belt assembly as previously described would then be attached to the back of cantle 6 of saddle 1A. The leather of cantle 6 would be used to secure faux belt 56 via rivets 59, with buckle 42 secured to saddle 1A via Conway buckle 58 in the manner as previously described.

It also is within the scope of the present invention that it be used with newly-constructed saddles, as well as retrofitting previously-manufactured saddles. For example, a previously made saddle could have the skirts dis-assembled from the saddle tree, and the fleece removed. Thereafter, appropriate cuts would be made into the leather of the skirt such that the faux belt and the Conway buckle may be attached to the skirt such as with rivets. The skirt would then be refleeced and reattached to the saddle structure as conventionally done.

To retrofit in accordance with cantle mount embodiments, the top of the cantle may unstitched. The leather off the rear of the cantle may then be removed and proper cuts to insert and secure the belt and the Conway buckle. These items preferably would be riveted into place such as previously described and then the leather would be reattached to the back of the cantle. From there, the top of the cantle would be restitched, and the saddle would be ready for use.

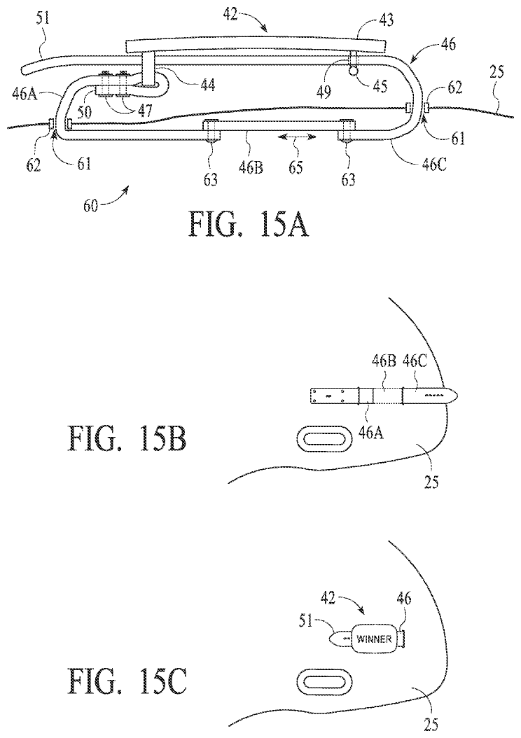

As an example of an alternative embodiment that may be used in a newly-manufacture saddle embodiment or a retrofit embodiment, reference is made to FIGS. 15A-C. As illustrated, in this embodiment a “miniature” western style belt is used as an alternative to the faux belt of earlier described embodiments and engages with a western style belt buckle in a more conventional manner, as generally denoted by 60. Belt body 46 is illustrated to have three sections (46A, 46B and 46C) in this exemplary embodiment (in variations of this embodiment, there is only a single body element utilized), which loops through a pair of slits 61 in skirt 25 (slits 61 are optionally protected by eyelet implements 62, which serve to provide a protective edge to slits 61. As illustrate, belt body 46 engages buckle 42, having body 43, bar 44 and post 45, much as described in reference to FIG. 9. Belt head 50 of belt portion 46 loops around bar 44 and is secured back onto itself preferably by snaps or Chicago screws 47 (the discussion in reference to FIG. 9 is incorporated herein by reference with respect to these embodiments). Belt portion 46A preferably then extends into the left-shown slit 61 (preferably protected by eyelet 62) and traverses under the leather of skirt 25. In certain preferred alternative embodiments, belt portion 46A attaches to belt portion 46B via rivets 63 (or other secure mounting elements), with a pair of rivets preferably utilized at the connection point. Belt portion 46B preferably then connects with belt portion 46C, again connected via rivets 63 (or other secure mounting elements), with a pair of rivets preferably utilized at the connection point. Belt portion 46 then follows the illustrated path under skirt and comes out right most slit 61 (preferably protected by eyelet 62). Belt portion 46 then extends to belt tail 51, and engages with post 45 of buckle 42 via hole 49 (reference is again made to FIG. 9) and passes through bar 44 of buckle 42 in a conventional for western-style belts and buckles as previously described.

As previously mentioned, such embodiments may alternatively utilize a single piece belt body 46 in lieu of the three-part belt implementation. In preferred alternative embodiments, however, belt portion 46B is interposed between belt portions 46A and 46C. Belt portions 46A and 46C preferably consist of leather as in conventional western style belts. Belt portion 46B, however, consists of an elastomeric or rubber material or other stretchy material such as materials used in rubber bands or bungee cords. When belt 46 fully engages buckle 42 with post 45 going to into one of holes 49, belt tail 51 is pulled to put belt portion 46 in a state of tension, denoted by arrow 65. As will be appreciated by those of skill in the art, such a multi-part belt configuration puts the portion of belt body 46 engaged with post 45 in a state of tension, increasing the holding power of belt body 46 to post 45/buckle 42.

Such alternative embodiments are further illustrated in FIGS. 15B and 15C. FIG. 15B illustrates the portions of miniature western-style belt (46A, 46B and 46C) in an open position, not yet engaged with a belt buckle. FIG. 15C illustrates belt body 46 (which again preferably consists of the three portions 46A, 46B and 46C but which could as single body 46 preferably consisting of leather), engaged and securing buckle 42 to skirt 25. Tail 51 extends from buckle 42 as illustrated. Also, it should be understood that such miniature belt embodiments also may be located on the cantle portion of the saddle, such as with earlier described embodiments.

Also within the scope of the present invention are additional holding elements to increase holding force of the post of the belt buckle and the leather of the belt, which are usable with either faux belt or miniature belt embodiments as elsewhere described herein. Alternative embodiments incorporate such additional holding elements as will be described with reference to FIGS. 16-22. The discussion hereinafter is applicable to faux belt 56 as well as belt body 46.

FIG. 16 illustrates buckle 42, having bar 44, body 43 and post 45. Belt body 46 is shown engaging just with post 45, but this is for explanation purposes for the additional holding elements, which should be understood to be used with the previously described faux belt and miniature belt embodiments. As illustrated in this alternative, securing member 67 securably engages with post 45 to as to more tightly hold belt body 46 in place against body 43. Top securing element 68, preferably has a diameter or width dimension greater securing member 67 and hole 49 in belt body 46 into which post 45 is positioned. As will be appreciated, with securing member 67 secured to post 45, and securing member 67 extending through hole 49 and being topped by top securing element 68, belt body 46 is more securely affixed and held in place relative to buckle 42 via post 45.

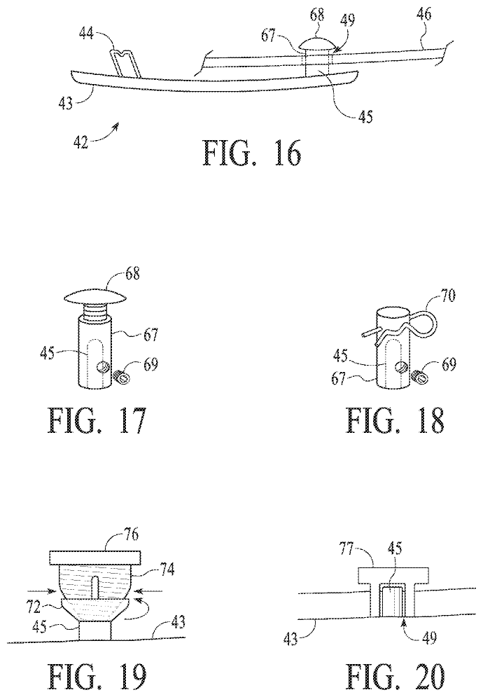

As illustrated in FIG. 17, securing member 67 may be a cylindrical-shaped tube which may be made of metal or other rigid or semi-rigid materials that may be secured to post 45 such as by way of set screw 69. In the illustrated embodiment, securing member 67 is secured to post 45, and securing member 67 extends through belt body 46 and may then be secured to belt body 46 by way of, for example, top securing element 68, which may be as illustrated a threaded member that inserts into securing member 67. It should be noted that top securing member 68 may also be a snap in feature as opposed to a threaded feature. The important point is that top securing member 68, when provided, may be threaded or snapped onto securing member 67 to more tightly hold the buckle to the belt, and thereafter may be unthreaded or unsnapped in order to remove buckle 42 from belt body 46. In such alternative preferred embodiments, securing member 67 (and top securing member 68, if provided) are removably securable relative to post 45, so that buckle 42 is securably removable relative to belt body 46, or faux body 56, depending on the embodiment.

As illustrated in FIG. 18, as an alternative securing member 67 may have a through-hole at the portion that will extend through and out of hole 49. With such a through-hole, securing member 67 may be removably secured to belt body 46 or faux belt 56 such as by way of a small pin, with cotter-style pin 70 being exemplary.

As illustrated in FIG. 19, another variant of a securing mechanism used in yet other alternative embodiments is illustrated. Deforming member 72 is positioned over post 25 (which in actual use would be through a hole 49, and deformed member 74 surrounds or substantially surrounds post 45. Deformed member 74 has top portion 76, preferably of a widened diameter or shape relative to deformed member 74, and may engage with deforming member 72 (such as by way of threads 74) such that as deforming member 72 engages with deformed member 74, deformed member 74 compresses onto post 45 and effectively “grabs” post 45, much like removable screw driver tips are secured to a screw driver handle by a twisting action, or a drill press and a drill bit. What is important is that deformed member 74 engages with post 45 to be removably securable thereto.

As illustrated in FIG. 20, another variant of a securing mechanism used in yet other thinner than its top portion is pushed onto post 45 when positioned in hole 49. Grommet structure 77 preferably is of a relatively stiff elastomeric material, with significant slip resistance, such that it may be pushed onto post 45 and take considerable force to pull off post 45. Grommet structure 77 provides yet another exemplary securing member for helping removable secure belt body 46 or faux belt 56 to buckle 42 via post 45 and hole 49.

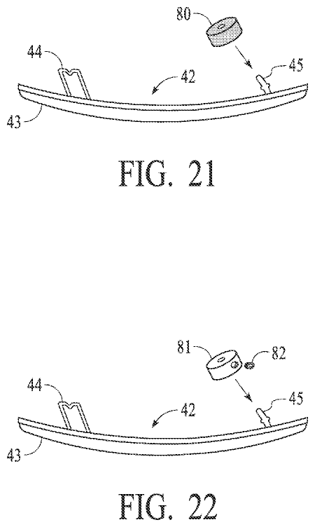

As illustrated in FIG. 21, another grommet style securing member 80 is illustrated, similar to the embodiment described with reference to FIG. 20. Grommet structure 80 preferably is of a relatively stiff elastomeric material, with significant slip resistance, such that it may be pushed onto post 45 and take considerable force to pull off post 45. Grommet structure 80 provides yet another exemplary securing member for helping removable secure belt body 46 or faux belt 56 to buckle 42 via post 45 and hole 49.

As illustrated in FIG. 22, an alternate ferrule-type securing member 81 is illustrated, similar to the embodiment described with reference to FIGS. 20 and 21. Ferrule structure 81 preferably is made of metal or rigid plastic and preferably has set screw 82 as a securing mechanism for securing ferrule structure 81 to the tip portion of post 45. With set screw 82 engaged, ferrule structure 81 engages post 45 such that it may be secured onto post 45 and take considerable force to pull off post 45. Ferrule structure 81 provides yet another exemplary securing member for helping removable secure belt body 46 or faux belt 56 to buckle 42 via post 45 and hole 49.

Also, in accordance with alternative embodiments, other means for mounting commemorative buckles to saddles are utilized. As one example, Chicago screws (or alternatives as previously mentioned) may be used. As an illustrative example, the buckle may be modified by having the bar and post removed and having the female threaded end of a Chicago style screw set soldered to the body of the buckle in 3 or 4 spots. Holes would then be punched into the skirt and through the fleece to allow the male end of the Chicago screw to go through and then be threaded into the female end. This would enable the buckle to directly attached to the saddle, much like silver accents or medallions. In accordance with such alternative embodiments, buckles would be modified and not maintained as typical western-style buckles.

As another alternative embodiment, a Velcro-style hook and loop (Velcro™) may be used. Rather than attaching with a faux belt, hook and loop straps would be an option. This may be accomplished, for example, by sewing the loop side to the underside of a short leather strap close to a rivet mount. The hook side would be mounted further up the strap. In place of the Conway buckle there would be another strap the same width as the base strap. It would be riveted to the skirt preferably with two rivets to keep it from spinning. There will be one reinforced hole (such as with a metal eyelet) in this short strap for the post. To mount the buckle, insert the post in the hole of the short strap, then wrap the base strap through the bar, pull tight and secure the strap to itself.

As yet another alternative embodiment, the implementation is much as previously described with respect to the preferred embodiments, but a Conway buckle style of securing element is not used. In such embodiments, for example, the faux belt may kept one width and one or two snaps (or sets of snaps, one male and one female) are attached to the skirt of the saddle and to the tail of the faux belt. In accordance with such alternative embodiments, the belt may be slid through the bar buckle, the post inserted into one of the provided holes and then firmly snap the snaps into place.

As yet another alternative embodiment, the implementation would be much as just previously described but the snaps on the belt tail would are eliminated and the tail end of the strap is rived in, for example, two places to the saddle skirt, after the buckle has been attached to the belt. This option will eliminate the ability to swap out buckles easily.

As yet another alternative embodiment, magnets are utilized. With such embodiments, a faux belt may be attached to the bar on the buckle, which is ideally looped through and then snapped back to itself with snaps. In addition to or in lieu of a post on the buckle, a strong magnet would be sewn into a leather pouch or pocket in the proper location of the skirt. This would keep the magnet secure. A second properly polarized magnet would be attached (such as with adhesive or a bracket mechanism) to the buckle and upon installation would hold the post of the buckle secure. In one particular such alternative embodiments, a disk or plate shaped magnet has a hole in the interior (e.g., center of a circular disk) such that the post is positioned within the hole of the magnet.

What is important from such embodiments, commemorative belt buckles may be secured to saddles for display and enjoyment with a variety of attachment mechanisms.

It should also be understood that the specific design elements of the saddle are exemplary and illustrative. The present invention is not limited to any specific design of saddle, in regard to style, color or type of saddle. As will be appreciated by those of skill in the art, embodiments of the present invention may be used on all variations of the Martha Josey Saddle whether it be a barrel saddle, roping saddle, all around saddle, cutting saddle, team penning saddle, or any other saddle. The Gold Buckle Saddle, The Gold Buckle name, and the Gold Buckle concept of attaching western buckles, trophy buckles, award buckles or any other type of commemorative buckle to a saddle to be used in western riding, for example, are within the scope of inventions by the co-inventors hereof.

Although the invention has been described in conjunction with specific preferred and other embodiments, it is evident that many substitutions, alternatives and variations will be apparent to those skilled in the art in light of the foregoing description. Accordingly, the invention is intended to embrace all of the alternatives and variations that fall within the spirit and scope of the appended claims. For example, it should be understood that, in accordance with the various alternative embodiments described herein, various systems, and uses and methods based on such systems, may be obtained. The various refinements and alternative and additional features also described may be combined to provide additional advantageous combinations and the like in accordance with the present invention. Also as will be understood by those skilled in the art based on the foregoing description, various aspects of the preferred embodiments may be used in various subcombinations to achieve at least certain of the benefits and attributes described herein, and such subcombinations also are within the scope of the present invention. All such refinements, enhancements and further uses of the present invention are within the scope of the present invention.

What is claimed is:

1. A saddle adapted for securing and displaying a commemorative belt buckle, comprising:
a saddle skirt;
a faux belt have a first end secured to the saddle skirt and a second end, the faux belt adapted to be removably secured to the commemorative belt buckle via a bar and post of the commemorative buckle and one or more holes through the faux belt;
a belt securing element secured to the saddle skirt;
wherein the second end of the faux belt is removably secured to the saddle via the belt securing element, wherein the commemorative belt buckle is removably secured to the saddle.

2. A saddle adapted for securing and displaying a commemorative belt buckle, comprising:
a display portion, wherein the display portion provides an area for securing and displaying a commemorative belt buckle;
a belt adapted to be secured in the display portion, wherein the commemorative belt buckle is adapted to be removably secured to the belt via a bar and post of the commemorative buckle and one or more holes through the belt;
wherein the commemorative belt buckle is removably secured to the saddle.

3. The saddle of claim 2, wherein the display portion comprises a rear skirt portion or a cantle of the saddle.
